(19) United States
(12) Patent Application Publication
(10) Pub. No.: US 2013/0235704 A1
(43) Pub. Date: Sep. 12, 2013

(54) PORTABLE ELECTRONIC TIMEPIECE WITH TOUCH SENSITIVE USER INTERFACE

(71) Applicant: MOVADO LLC, Wilmington, DE (US)

(72) Inventor: Efraim Grinberg, New York, NY (US)

(73) Assignee: Movado LLC, Wilmington, DE (US)

(21) Appl. No.: 13/784,042

(22) Filed: Mar. 4, 2013

Related U.S. Application Data
(60) Provisional application No. 61/607,228, filed on Mar. 6, 2012.

(51) Int. Cl. G04G 21/08

(52) U.S. Cl. CPC G04G 21/08
USPC 368/69

(57) ABSTRACT

A portable electronic timepiece (timepiece) with a touch sensitive user interface. The timepiece can be transitioned from a sleep mode to a wake mode by touching a particular area on the touch interface for pre-determined period of time (a dwell input). In the wake mode, the timepiece can interpret a variety of user inputs, including dwell and swipe inputs, and can alter the information shown on the display accordingly. A swipe input can trigger a variety of functions depending on the location, direction and path of the swipe across the touch interface. A dwell input can also trigger other functions depending on how long the dwell lasts and where on the touch interface it occurs. The timepiece can also include a combination of one or more touch buttons and a touch interface.

This application claims the benefit of priority under 35 U.S.C. §119 from U.S. Provisional Patent Application No. 61/607,228, entitled “Portable Electronic Timepiece With Touch Sensitive User Interface,” filed Mar. 6, 2012, which is hereby incorporated by reference in its entirety.

### TECHNICAL FIELD OF THE INVENTION

This patent application relates generally to the field of portable electronic timepieces, in particular, to digital watches that have touch sensitive user interfaces.

### BACKGROUND OF THE INVENTION

Traditionally, wrist watches have been constructed as complex mechanical devices. With the advent of digital wrist watches and the continued realization of Moore's law, the functionality and popularity of digital watches has increased dramatically and the cost has decreased.

Digital watches however are not without limitations. By example, early digital watches had segmented displays that used LED technology to show time. Such displays consume a significant amount of power. In order to prolong battery life, the display is arranged to show the time only after a user physically depresses a button. The display powers-off shortly after the user releases the button.

Yet another drawback to traditional digital watches is the myriad of buttons used to control their functionality. Since each button has limited, dedicated functions, additional buttons are required which come at the expense of intuitive use and which require complex actions and manipulation to control the device.

Mechanical buttons on watches also have the limitation of not discriminating between an inadvertent actuation and one intended by the user. Not only can inadvertent actuation interfere with the intended use of the watch, but this can lead to more significant problems such as draining the power supply or affecting settings.

The introduction of the touch-interface has created an infinite number of possible user inputs and has eliminated the need for multiple buttons to control a highly functional digital device. Touch-interfaces have become popular with the proliferation of smart phones. One further benefit to a touch-interface is that it is Most receptive to touch from human skin and not an inadvertent touch by an inanimate object, including clothing, thereby decreasing the possibility of inadvertent actuation.

It can be appreciated that digital watch constructions that can be activated with a simple interaction by the user are desired in the art. Moreover, the activation of such watch constructions, while simple when intended by the user, are advantageously constructed so as to prevent inadvertent activation either by the user or an object coming into contact with the watch.

It is with respect to these and other considerations that the disclosure made herein is presented.

### BRIEF DESCRIPTION OF THE DRAWINGS

FIG. 1 is a high-level diagram illustrating an exemplary configuration for a portable electronic timepiece;

FIG. 2 is a flow diagram showing a routine that illustrates a broad aspect of the operation of a portable electronic timepiece in accordance with at least one embodiment disclosed herein;

FIG. 3 depicts an exemplary portable electronic timepiece in accordance with at least one embodiment disclosed herein shown in a sleep mode;

FIG. 4 depicts the embodiment of FIG. 3 being actuated;

FIG. 5 depicts the embodiment of FIG. 3 showing information in a wake mode;

FIG. 6A the embodiment of FIG. 5 being actuated while in the wake mode;

FIG. 6B depicts the embodiment of FIG. 5 now showing alternate information;

FIG. 7 depicts the embodiment of FIG. 5 being actuated to the sleep mode of FIG. 3;

FIG. 8 depicts an optional intermediate mode prior to transitioning to the sleep mode of FIG. 3; and

FIG. 9 illustrates another embodiment of a timepiece having plural buttons.

### DETAILED DESCRIPTION OF CERTAIN EMBODIMENTS OF THE INVENTION

By way of overview and instruction, systems and methods are described herein that facilitate and enable a portable electronic timepiece (timepiece) with a touch sensitive user interface. It can be appreciated that traditional digital watches allow a user to wake the device from an inactive mode by actuating a push button. Furthermore, push buttons can be easily actuated inadvertently which can drain battery power prematurely. Devices with touch interfaces, such as smart phones, commonly require complex procedures requiring push buttons and touch screen inputs to transition the device from an inactive or sleep mode to a fully operational or wake mode. For example waking an Apple iPhone requires pushing the button to activate the screen then touching the device in one location and dragging a finger across the device in a pre-determined path to unlock the device.

In an effort to provide a portable electronic timepiece that can be easily activated, minimizing inadvertent activation and provides extensive functionality, the system and methods described herein enable a series of operations whereby a user can transition a portable electronic timepiece from a sleep mode to a wake mode with the simple act of touching a particular area on the touch interface for a set period of time (also referred to as a dwell). A user dwell is not limited to triggering a wake or sleep mode but can also trigger a variety of other functions depending on how long the dwell lasts and where on the touch interface that it occurs. Once in a wake mode, the timepiece becomes fully operational, and can interpret a variety of user inputs on the touchscreen, such as a continuous touch (or swipe) from left to right or right to left and alter the information shown on the display in response. It should be understood that a swipe input can trigger a variety of functions depending on the location, direction and path of the swipe across the touch interface. The portable electronic timepiece could also include a combination of one or more touch buttons and a touch interface.

The following detailed description is directed to systems and methods for a portable electronic timepiece with a touch-sensitive user interface. The referenced systems and methods are now described more fully with reference to the accompanying drawings in which one or more illustrated embodiments and/or arrangements of the systems and methods are shown. The systems and methods are not limited in any way to the illustrated embodiments and/or arrangements which rather are exemplary. Therefore, it is to be understood that any structural and functional details disclosed herein are not to be interpreted as limiting the systems and methods, but rather are provided as a representative embodiment and/or arrangement for teaching one skilled in the art one or more ways to implement the systems and methods. Accordingly, aspects of the present systems and methods can take the form of an entirely hardware embodiment, an entirely software embodiment (including firmware, resident software, micro-code, etc.), or an embodiment combining software and hardware. One of skill in the art can appreciate that a software process can be transformed into an equivalent hardware structure, and a hardware structure can itself be transformed into an equivalent software process. Thus, the selection of a hardware implementation versus a software implementation is one of design choice and left to the implementer. Furthermore, the terms and phrases used herein are not intended to be limiting, but rather are to provide an understandable description of the systems and methods.

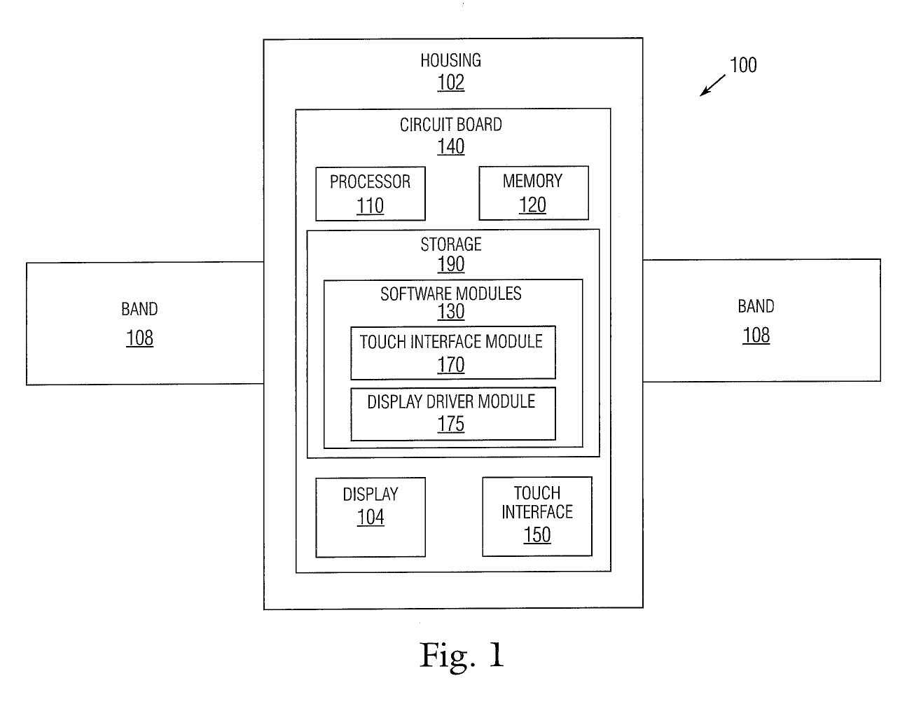

An exemplary portable electronic timepiece 100 is shown in the high-level diagram of FIG. 1. The timepiece 100 comprises a housing 102 and a band 108. The band 108 can be made fixedly or removably attached to the housing 102 or can be integral to the housing 102. The band 108 can secure the timepiece 100 around a user's wrist but it is generally understood that it need not be worn in the traditional sense. The band 108 or the housing 102 can be made of any durable synthetic or natural material such as leather, polymer, metal or any combination thereof.

The timepiece 100 further comprises a circuit board 140, such as a motherboard, which is operatively connected to various hardware and software components that serve to enable operation of the timepiece 100. The circuit board 140 is operatively connected to a display 104, and a touch interface 150, and a processor 110. Optionally, there is a memory 120 which is shown merely for purposes of illustration and not to limit any particular embodiment. Processor 110 serves to execute instructions for software that can be loaded into a buffer accessible to the processor or from the memory 120. Processor 110 can be a number of processors, a single, a multi-processor core, or some other type of processor, depending on the particular implementation.

Display 104 is also operatively connected to the processor 110. Display can be a digital display such as a segment display, a dot matrix display or a 2-dimensional display and can incorporate, by way of example and not limitation, a liquid crystal display, light emitting diode display, electroluminescent display, or electronic paper. The display provides an output to the user of information such as the local time, a second time zone, the date, and so on, as a function of the mode of the watch as managed by instructions executing in the processor 110.

Touch interface 150 is also operatively connected to the processor. The touch interface 150 is a transparent interface that is placed in register on the top of the display 104 or on/around the perimeter of display 104. A touch interface is comprised of one or more thin, transparent layers that can detect when and where a user touches the interface and it allows a user to interact directly with what is displayed without requiring an intermediate device such as a computer mouse. The touch interface 150 can be constructed using, by way of example and not limited to, resistive, capacitive, acoustic, infrared, optical imaging, or dispersive signal technology. The touch interface 150 provides an input to the user for obtaining commands that are provided to the processor, as described below, in order to control the state or mode of operation of the timepiece 100.

A memory 120 and/or storage 190 are accessible by processor 110, thereby enabling processor 110 to receive and execute instructions stored on memory 120 and/or on storage 190. Memory 120 can be, for example, a random access memory (RAM) or any other suitable volatile or non-volatile computer readable storage medium. In addition, memory 120 can be fixed or removable.

Alternatively, in one particular implementation, storage 190 can take various forms. For example, storage 190 can contain one or more components or devices such as a hard drive, a flash memory, a rewritable optical disk or some combination of the above. Storage 190 also can be fixed or removable. In implementations in which removable storage can be mounted so as to be accessible to the processor 110 and the operating system of the timepiece 100, data on the removable storage device can be presented to the user through the display 104 as a function of the mode of the timepiece 100, as managed by instructions executing in the processor 110.

One or more software modules 130 are encoded in storage 190 and/or in memory 120. Optionally, other data such as images can be encoded in the storage 190 and/or the memory 120. Such images can be selected and/or provided as a background image as part of the display of information to a user when the timepiece is in an awake state. The software modules 130 can comprise one or more software programs or applications having computer program code (e.g., a set of instructions) that execute in the processor 110. Such computer program code is provided for carrying out operations for aspects of the systems and methods disclosed herein, and can be written in a low level assembly language.

Included among the software modules 130 is a touch interface module 170 and display driver module 175 that are executed by processor 110. During execution of the software modules 130, and specifically the touch-input processing application 170, and the display driver module 175, the software modules 170 configure the processor 110 to perform various operations that drive the display 104 in response to a user's interaction with the touch interface 150, as will be described in greater detail below. It should also be noted that while FIG. 1 depicts memory 120 oriented on circuit board 140, this is not required. In an alternate arrangement, memory 120, if provided, can be operatively connected to the circuit board 140 or integral with the processor 110 and other components as a single, integrated circuit. In addition, it should be noted that other information and/or data relevant to the operation of the present systems and methods can also be stored on separate storage 190, if provided in a particular implementation as will be discussed in greater detail below.

Embodiments and/or arrangements can be described in a general context of computer-executable instructions, such as program modules, being executed by a computer. Generally, program modules include routines, programs, objects, components, data structures, etc., that perform particular tasks or implement particular abstract data types.

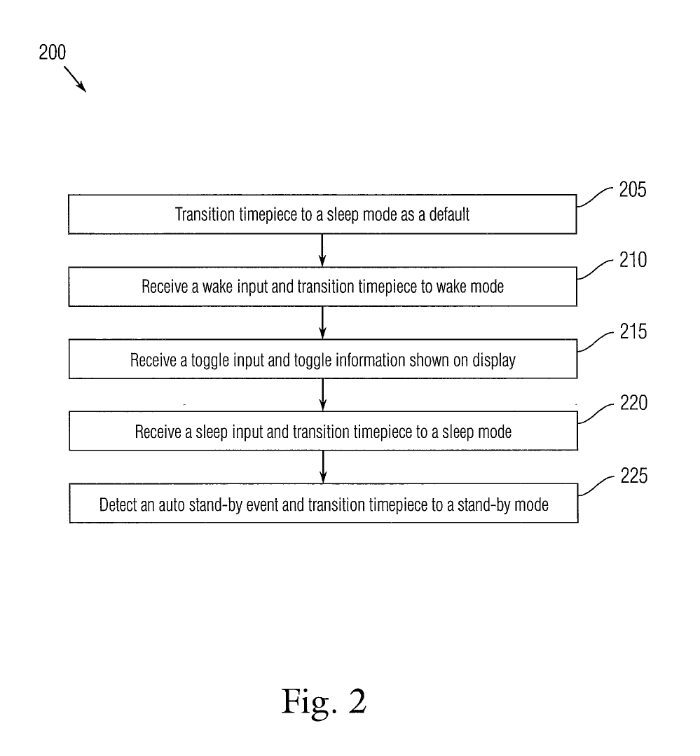

Turning now to FIG. 2, a flow diagram is described showing a routine 200 that illustrates a broad aspect of a method for the operation of a portable electronic device in accordance with at least one embodiment disclosed herein. It should be appreciated that several of the logical operations described herein are implemented (1) as a sequence of computer implemented acts or program modules running on timepiece 100 and/or (2) as interconnected machine logic circuits or circuit modules within the timepiece 100. The implementation is a matter of choice dependent on the requirements of the device (e.g., size, energy, consumption, performance, etc.). Accordingly, the logical operations described herein are referred to variously as operations, steps, structural devices, acts, or modules. It should also be appreciated that more or fewer operations can be performed than shown in the figures and described herein. These operations can also be performed in a different order than those described herein.

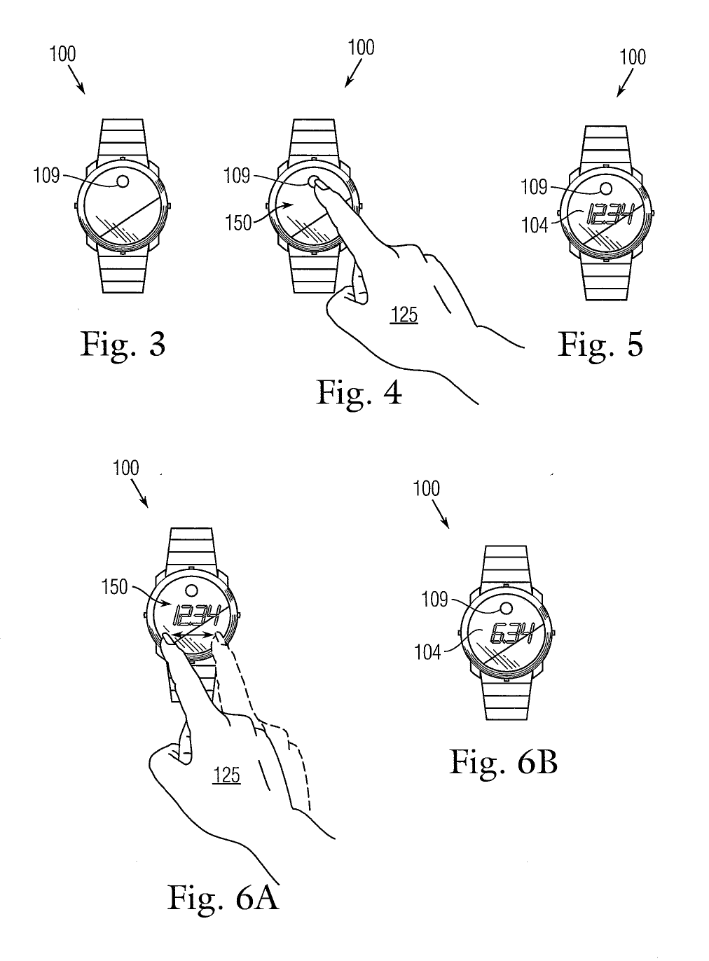

The process begins at step 205 at which processor 110 executes one or more of software modules 130, including touch interface module 170 and display driver module 175 to configure the timepiece 100 to default to a sleep mode. When in a sleep mode, at least some of the constituent electronic components of the timepiece 100 are inactive or in a state of relative inactivity and as a result the timepiece 100 can conserve power. FIG. 3 shows an exemplary timepiece in a sleep mode. It can be appreciated from FIG. 3 that when the timepiece 100 is in the sleep mode, the timepiece 100 can be configured such that the display 104 is devoid of information (that is, it is free of any illumination), or, in the alternative, the display 104 can show only limited, selected information by a controlled illumination of only a portion of the display 104.

Then at step 210, the processor 110 executes one or more of software modules 130, including the touch-interface module 170 to configure the timepiece 100 to receive a wake input by way of the touch interface 150. A wake input received at the touch-interface is an indication that a user 125 intends to wake the timepiece 100 from an inactive state. Timepiece 100 detects a wake input by analyzing whether the user has interacted with the touch interface 150 for a pre-determined amount of time and in a pre-determined area of the display 104. In the event of a wake input, the timepiece 100 changes from sleep mode to wake mode in accordance with the code of the touch interface module 170 and the display driver module 175 that is executing in the processor 110.

By way of example, in reference to FIG. 4, the timepiece 100 can be configured to wake after a user 125 touches the touch interface 150 at the button area 109 marked by a circle and the touch remains stationary for between 1-2 seconds, this is also referred to as a dwell input. The area 109 can comprise a color circle in a variety of color choices to complement the timepiece. The button area 109 can comprise a permanently rendered feature (as in the present illustrations) as opposed to an illuminated portion of the display 104. However, the button area 109 need not be rendered on the display 104 at all and its location can vary and is not limited to a particular shape. Furthermore, the duration of the stationary interaction with the touch interface 150 required to prompt the timepiece to transition to a wake mode can be established by the code or hardware so as to be between 0.5 and 5 seconds, and more specifically between 1 and 3 seconds and preferably exactly one second.

In other devices, such as smart phones, the user must perform a rather complex task of first pushing a mechanical button to activate the screen and then touching the touchscreen in a particular location and moving his finger along a pre-defined path in order to wake the device. According to the present invention, the user can wake the timepiece 100 from a sleep mode by simply touching and remaining stationary (i.e. a dwell) at a specific location of the touch interface 150 without the need for (i.e., being free of) any mechanical buttons whatsoever. It can be appreciated that the function carried out by the timepiece 100 in response to a user's stationary input is not limited to transitioning from a wake to a sleep mode as described above. The timepiece 100 can be configured to perform other operations depending on the duration of a dwell or the location of a dwell in accordance with the code of the touch interface module 170 that is executing in the processor 110. By way of example, a user' dwelling at button 109 for between 2 and 10 seconds can correspond to a user command to set the hour displayed. The user can then change the hour up or down by swiping horizontally across the device similar to how a user can toggle between displays in wake mode as is described below.

FIG. 5 shows an exemplary timepiece 100 in a wake mode. When the timepiece 100 is set to a wake mode, it is fully functional operationally and configured to show information on the display 104. When the timepiece 100 transitions from a sleep to a wake mode the timepiece 100 is configured to default to displaying a first display, which can be, by way of example, the current time. Other defaults can be programmed in alternative implementations. Furthermore, in wake mode, the timepiece is configured to respond to a broader set of user interactions with the touch interface 150 and to display information other than the first time, such as the date or the time in a second time zone.

Then at step 215, the processor 110 executes one or more of software modules 130, including the touch interface module 170 to configure the timepiece 100 to receive a toggle input by way of the touch interface 150. A toggle input received at the touch-interface 150 is an indication that the user 125 intends to change the information displayed by the timepiece 100. The timepiece 100 can determine whether an input received at the touch-interface 150 is a valid toggle input by detecting the user's path of continuous contact with the touch interface 150 and analyzing the vector of the user's contact. According to the vector of the user's touch, the timepiece 100 can toggle the information shown on the display 104 to an alternative display in accordance with the code of the touch interface module 170 and the display driver module 175 that is executing in the processor.

By way of example, in reference to FIG. 6A, while already in a wake mode, and displaying the default first display, time 1, the timepiece 100 can be configured to display an alternate display, time 2, when the timepiece 100 detects a user's 125 left to right horizontal a swipe across the touch interface 150. FIG. 6B depicts the timepiece displaying the alternate display, time 2, after detecting the toggle input. Similarly, the timepiece 100 can be configured to display yet another alternate display, date, when the timepiece 100 detects a user's right to left horizontal a swipe across the touch interface 150.

There is a limitless amount of information that the timepiece 100 can be configured to display as a default or in response to a user's toggle input. In certain alternative constructions having a suitable display element and additional memory components as described above, timepiece 100 can be configured to show images or weather data which can be stored in memory 120 or storage 190. In addition, there are a myriad of ways in which a user can cycle through the various alternative displays. For example, a user 125 continuously swiping from left to right can first toggle from time 1 to time 2 to date and back to time 1, and repeat the cycle so long as the user 125 keeps swiping. In alternative constructions, actionable user input can include swipes across the touch interface 150 other than horizontal, such as any pre-defined interaction with the touch interface 150 that can be interpreted by the processor 110, e.g. tracing an S shape or a U. These various configurations and functions can be realized in accordance with the touch interface module 170 and the display driver module 175 that are executing in the processor 110.

Then at step 220, the processor 110 executes one or more of software modules 130, including the touch-interface module 170 to configure the timepiece 100 to receive a sleep input by way of the touch interface 150. A sleep input received at the touch-interface 150 is an indication from a user that the user 125 intends to transition the timepiece 100 to a sleep mode which is also referred to as a sleep input. While in a wake mode, timepiece 100 can detect a sleep input by analyzing whether the user has interacted with the touch interface 150 for a pre-determined amount of time and in a pre-determined area of the display 104. In the event of a sleep input, the timepiece 100 transitions from wake mode to a sleep mode in accordance with the code of the touch interface module 170 and the display driver module 175 that is executing in the processor.

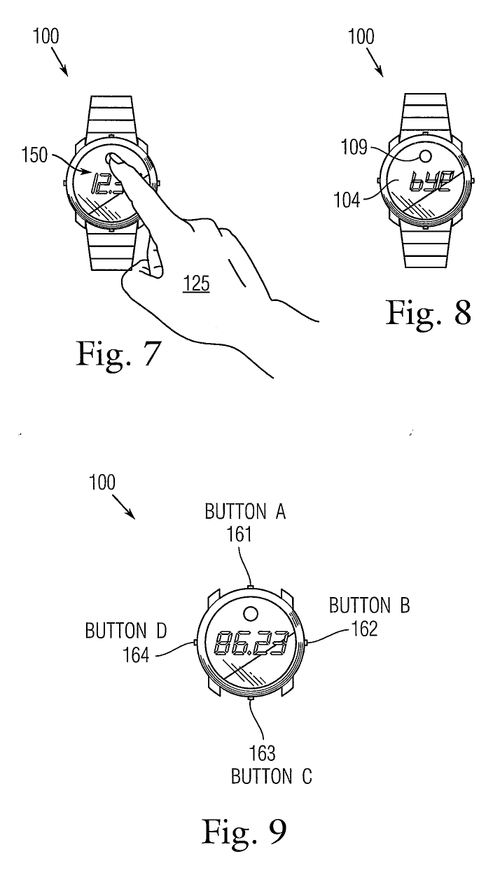

By way of example, in reference to FIG. 7, the timepiece 100 can be configured to transition to a sleep mode after a user 125 touches the touch interface 150 at the button area 109 marked by a circle and remaining stationary for between 2-3 seconds. After the timepiece detects a valid sleep input, the timepiece 100 can transition from a wake mode where the display is lit to a sleep mode where the display can be in-active. As an intermediate step, after receiving a valid sleep input but before entering a sleep mode, the timepiece 100 can be configured to temporarily show a message on the display 104 such as “BYE”, indicating that it is entering into a sleep mode as shown in FIG. 8.

Then at step 225, the processor 110 executes one or more of software modules 130, including the touch-interface module 170 to configure the timepiece 100 to detect an auto-stand-by event. An auto-stand-by event is an indication that the user 125 no longer intends to interact with the timepiece 100. Timepiece 100 detects an auto-stand-by event by determining if and when the user has last touched the touch interface 150 and analyzing whether that occurred within a pre-determined amount of time. In the event that the user has not interacted with the touch interface within the pre-determined amount of time, the timepiece 100 transitions automatically from a wake mode to a stand-by mode in accordance with the code of the touch interface module 170 and the display driver module 175 that is executing in the processor. By way of example, the timepiece can be configured to go to stand-by mode after not detecting a user input by the touch interface 150 for a period of 5 seconds. Furthermore, by way of example, in the stand-by mode the timepiece 100 can be configured to de-activate display 104 and remain inactive until a user touches the touch interface 150. Alternatively, the timepiece can be placed into a sleep mode by touching the area 109 for a prescribed time period when the timepiece is presently in the activated state.

FIG. 9 shows an exemplary timepiece 100 further comprising one or more touch buttons. Button A 161, button B 162, button C 163 and button D 164 are electronic switches that are operatively connected to the processor 110. A touch button is an input device with two states, on and off, with which the user can direct the timepiece 100 to perform a function in accordance with code executing in the processor 110. By example, touching button A 161 can perform the wake or sleep functions described above. Or in addition, the timepiece 100 can be configured to prompt the user to set the time 1 shown on display 104 when user touches button A 161 and dwells there for a pre-determined period of time (e.g. two seconds). The user can then toggle through the hour, minute, day or year and adjusting the value up or down by either touching one or more of the touch buttons or touching the touch interface 150 in a pre-defined way in accordance with code executing on the processor 110. To change the hour displayed, the user 125 can touch the touch interface 150 and drag his finger, for example, horizontally, to increase the time value displayed.

From the foregoing, therefore, the invention can be characterized, in one aspect, as a portable electronic timepiece comprising a band, a case attached to the band, a display, a touch-interface in registry with the display, a memory, a processor, a display driver module comprising code stored in the memory, and a touch-interface module comprising code stored in the memory. The processor can be configured by the modules to respond to the touch-interface and to control the display. The touch interface module, when executed in the processor, can configure the processor to detect a user-interaction with the touch interface at a first location for a first duration, transition the display driver module to an active state and displays a first display upon detection of user-interaction at the first location for a pre-determined duration, transition the display driver module to an inactive state and the touch-interface module to a stand-by mode after a pre-determined period without user-interaction with the touch-interface, and display an alternative display when the touch-interface module is in an unlocked state in response to a swipe-gesture detected at the touch-interface along a pre-defined input path.

In the foregoing description, certain features have been described in relation to certain embodiments of the invention, but these same features are to be understood as being useable in other arrangements and embodiments. Accordingly, the invention is defined by the recitations in the claims appended hereto and equivalents thereof, and is not limited to particular details of any of the foregoing embodiments that rather are provided to facilitate an understanding of the invention and to satisfy certain statutory requirements.

What is claimed:

1. A portable electronic timepiece having a band, a case attached to the band, one or more processors configured to interact with a display, a touch interface in registry with the display, a computer readable storage medium, and configured to execute instructions in the form of one or more software modules stored in the storage medium, comprising:
a touch-interface module that executes so as to configure the processor to detect a wake input on the user interface and transition the timepiece from a sleep mode to a wake mode responsive to a wake input; and
a display driver module that executes so as to configure the processor to display, on the display, a first display responsive to the wake input.

2. The system of claim 1, wherein the wake input is a user interaction with the touch interface for a pre-determined amount of time on a pre-determined area of the display.

3. The system of claim 2, wherein the pre-determined amount of time is between 0.5 and 5 seconds.

4. The system of claim 2, wherein the pre-determined amount of time is between 1 and 3 seconds.

5. The system of claim 2, wherein the pre-determined amount of time is 1 second.

6. The system of claim 1, wherein the touch interface is in an unlocked state when the timepiece is in the wake mode.

7. The system of claim 1, wherein the display is in the active state when the timepiece is in the wake mode.

8. The system of claim 1, wherein the touch-interface module executes to configure the processor to detect a toggle input when the timepiece is in the wake mode.

9. The system of claim 8, wherein the toggle input is a user interaction with the touch interface along a pre-defined path of continuous contact.

10. The system of claim 8, wherein the display driver module executes so as to configure the processor to transition the display to one or more alternative displays responsive to the toggle input.

11. The system of claim 1, wherein, responsive to a sleep input when the timepiece is in the wake mode, the processor configured by the one or more software modules executing therein, transitions the timepiece to the sleep mode.

12. The system of claim 11, wherein the sleep input is a user interaction with the touch interface for a pre-determined amount of time on a pre-determined area of the display.

13. The system of claim 12, wherein the pre-determined amount of time is between 2 and 5 seconds.

14. The system of claim 12, wherein the pre-determined amount of time is between 1 and 3 seconds.

15. The system of claim 12, wherein the pre-determined amount of time is 1 second.

16. The system of claim 11, wherein the touch interface is in a locked state when the timepiece is in the sleep mode.

17. The system of claim 11, wherein, when the timepiece is in the sleep mode, the display is in an inactive state and the touch interface is in a locked state.

18. The system of claim 11, wherein the processor transitions the display to an alternative display for a pre-determined period of time prior to transitioning the timepiece to the sleep mode.

19. The system of claim 1, wherein the touch-interface module executes to configure the processor to detect an auto-stand-by event when the timepiece is in the wake mode and transition the timepiece to a stand-by mode responsive to the auto-stand-by event.

20. The system of claim 19, wherein the auto-stand-by event is an absence of a user interaction with the touch-interface for a pre-determined period of time.

21. The system of claim 20, wherein the pre-determined period of time is 5 seconds.

22. The system of claim 19, wherein, the display is in an inactive state when the timepiece is in the stand-by mode.

23. The system of claim 19, wherein, responsive to a user interaction with the touch-interface when the timepiece is in the stand-by mode, the processor configured by the one or more software modules executing therein, transitions the timepiece to a wake mode.

24. The system of claim 19, wherein the touch-interface is in the locked state when in the stand-by mode.

25. The system of claim 1, wherein, responsive to a user interaction with the touch interface for a pre-determined amount of time on a pre-determined area of the display, the processor configured by the one or more software modules executing therein, transitions the timepiece to a setting adjustment mode.

26. The system of claim 25, wherein, when the timepiece is in the setting adjustment mode, the touch-interface module executes to configure the processor to detect a toggle input on the touch interface wherein the toggle input adjusts the one or more settings.

27. The system of claim 1, further comprising one or more touch buttons operatively connected to the processor, wherein the one or more touch buttons are two state electronic switches.

28. A computer-implemented method for displaying information to a user on a portable electronic timepiece of the type having one or more processors configured to interact with a display, a touch interface in registry with the display, a computer readable storage medium, and instructions in the form of one or more software modules stored in the storage medium and executable in the processor, comprising:
detecting a wake input on the user interface using the processor configured by the one or more software modules executing therein executing therein;
transitioning the timepiece from a sleep mode to a wake mode using the processor configured by the one or more software modules executing therein executing therein; and
displaying a first display responsive to the wake input using the processor configured by the one or more software modules executing therein executing therein.

29. The method of claim 28 further comprising, when the timepiece is in the wake mode, detecting a toggle input on the user interface, and transitioning the display to one or more alternative displays responsive to the toggle input using the processor configured by the one or more software modules executing therein.

30. The method of claim 28 further comprising, when the timepiece is in the wake mode, detecting a sleep input on the user interface, and transitioning the timepiece to the sleep mode responsive to the sleep input using the processor configured by the one or more software modules executing therein.

31. The method of claim 28 further comprising, when the timepiece is in the wake mode, detecting a sleep input on the user interface, and transitioning the timepiece to the sleep mode using the processor configured by the one or more software modules executing therein.

32. The method of claim 31 further comprising, prior to transitioning the timepiece to the sleep mode, displaying an alternative display for a pre-determined period of time using the processor configured by the one or more software modules executing therein.

33. The method of claim 31 further comprising, when the timepiece is in the wake mode, detecting an auto-stand-by event, and transitioning the timepiece to a stand-by mode using the processor configured by the one or more software modules executing therein.

34. The method of claim 33, further comprising, when the timepiece is in the stand-by mode, detecting a user interaction with the touch interface, and transitioning the timepiece to the wake mode using the processor configured by the one or more software modules executing therein.

35. The method of claim 28, further comprising, detecting a user interaction with the touch interface for a pre-determined amount of time on a pre-determined area of the display, and transitioning the timepiece to a setting adjustment mode using the processor configured by the one or more software modules executing therein.

36. The method of claim 35, further comprising, when the timepiece is in the setting adjustment mode, detecting a toggle input on the touch interface-, and adjusting the one or more settings responsive to the toggle input, using the processor configured by the one or more software modules executing therein.

37. The method of claim 28, further comprising, detecting, using the processor configured by the one or more software modules executing therein, a user interaction with one or more touch buttons operatively connected to the processor.
